(19) United States
(12) Patent Application Publication
(10) Pub. No.: US 2021/0335140 A1
(43) Pub. Date: Oct. 28, 2021

(54) AN EDUCATION TOOL

(71) Applicant: Gavin Mair, Buckinghamshire (GB)

(72) Inventor: Gavin Mair, Buckinghamshire (GB)

(21) Appl. No.: 17/272,334

(22) PCT Filed: Aug. 29, 2019
(86) PCT No.: PCT/GB2019/000123

§ 371 Date: Feb. 28, 2021

(30) Foreign Application Priority Data
Aug. 29, 2018 (GB) 1814072.3
Nov. 1, 2018 (GB) 1817907.7

(51) Int. Cl. G09B 1/06; G09B 3/06

(52) U.S. Cl. CPC G09B 1/06; G09B 19/02; G09B 3/06

(57) ABSTRACT

An education tool includes a sheet with a plurality of small pockets formed across a front face, and a rear pocket formed across a rear face. The sheet and the pockets are formed from a transparent material. The large rear pocket is configured so that an answer card can be inserted therein to show a series of answers frontwards, and a picture rearwards. The small pockets holding in use a plurality of question cards, their inner faces showing part of a larger picture, their outer faces showing a question. The question cards and answer card configured so that when all the question cards are inserted in the correct locations, the part pictures on their rear faces will mosaic to show substantially the same picture as on the rear of the answer card.

### FIELD

The present invention relates to an education tool for assisting teachers with assessing student answers. More particularly, the present invention relates to an education tool for assisting teachers with assessing student answers that allows the answers to be visually assessed quickly and easily without marking or calculation. Even more particularly, the present invention relates to an education tool for assisting teachers with assessing student answers that allows the answers of an individual or a group to be assessed by a teacher or the group quickly and easily without marking or calculation. The present invention also relates to an education tool for assisting teachers with assessing student answers and a method of using an education tool. The present invention also relates to an education tool, and a method of using an education tool

### BACKGROUND

One useful method for teaching children individually or as part of a group is to make the lesson seem like a game or as game-like as possible, in order to keep the lesson fun and absorbing for the pupils. One issue faced by teachers with this style of teaching is that of keeping the flow of the lesson going, without interruptions for marking or assessing the answers of individual students or the group. Marking a number of individual calculations, or even the answers of a single student, can be very time-consuming, and this can be highly disruptive to the flow of the lesson.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, Or form part of the common general knowledge in the art.

### SUMMARY

It is an object of the present invention to provide an education tool which goes some way to overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist in an education tool, comprising: a flat sheet having a front face and a rear face, and comprising a plurality of small pockets formed across at least part of the front face, and at least one rear pocket formed across at least part of the rear face, the flat sheet and the pockets at least partly formed from a substantially transparent material;

a plurality of answer cards, each answer card and each at least one large pocket mutually configured so that an answer card can be inserted into the large pocket to show a series of answers towards the front face; a plurality of question cards, the inner face of each question card showing part of a larger picture, the outer face showing a question; the flat sheet, question cards, and answer card all configured so that the question cards can be inserted within the small pockets over an answer showing through the flat sheet from an answer card inserted in the rear pocket, and further configured so that when all the question cards are inserted in the correct answer locations, the part pictures on their rear faces will mosaic to show at least one coherent picture.

In an embodiment, the answer card or cards may be further configured to show a picture towards the rear face, the picture corresponding to the correctly-mosaiced picture on the rear faces of the question cards.

In an embodiment, the flat sheet is substantially A3-sized.

In an embodiment, the flat sheet is substantially A4-sized.

In an embodiment, the small pockets are formed and arranged in a three-by-four grid.

In an embodiment, the at least one rear pocket is a pair of substantially identical pockets.

In an embodiment, the flat sheet and the pockets are at least partly formed from a substantially transparent material

In an embodiment, the front and/or rear pockets are formed by heat welding and/or stitching a transparent plastic material.

In an embodiment, the education tool further comprises a border, extending from at least one edge of the sheet, and comprising a connection means to allow two or more education tools to be connected together.

In an embodiment, the border extends from at least two edges of the sheet.

In an embodiment, the border extends around at least two edges of the sheet.

In an embodiment, the connection means comprises at least one snap-fastener.

In an embodiment, the connection means comprises velcro.

In a second aspect the present invention may broadly be said to consist in a method of using the education tool of any one of the preceding statements, the method comprising the steps of:
i) inserting at least one answer card into the at least one rear pocket of the education tool, the at least one answer card or cards having an answer or answers on the front face, the at least one answer card aligned so that the answer or answers can be viewed through the front face of the education tool;
ii) inserting a plurality of question cards into the front pockets over the answer or answers, each of the question cards having a question on the outer face and a portion of a mosaiced picture on the rear face, the portions of mosaiced picture on the rear faces forming a larger overall picture once all the question cards are inserted in the correct locations;
iii) removing the at least one answer card so as to view the rear faces of the question cards, and assessing the correctness of the mosaiced picture thus revealed.

In an embodiment, the method comprises the further initial step of fastening two or more education tools to one another.

In a third aspect the present invention may broadly be said to consist in a lesson mat, comprising: a flat, regularly-shaped mat body having a central portion adapted so that at least one education tool as outlined in any one of the preceding statements can be located in/on the central portion, and; a surrounding portion comprising a plurality of printed mosaiced shapes.

In an embodiment, the central portion is configured to receive a plurality of education tools.

In an embodiment, the education tool portion is a central portion.

In an embodiment, the central portion can receive six education tools.

In an embodiment, the central portion is shaped to receive the education tools in a 3×2 grid configuration.

In an embodiment, the printed mosaiced shapes of the surrounding portion comprise single small quadrilaterals and larger printed pictures.

In an embodiment, the single small quadrilaterals are sized to allow an averagely-sized pre-school child to stand on the quadrilateral substantially within the perimeter.

In an embodiment, the larger printed pictures are sized to allow an averagely-sized pre-school child to sit on the picture substantially within the perimeter of the picture.

In an embodiment, the larger printed pictures are the size and shape of four of the single small quadrilaterals arranged in a 2×2 grid.

In an embodiment, the small quadrilaterals are printed with simple geometric shapes, and at least one numeral.

In an embodiment, the at least one numeral comprises a numeral printed in a stylised and colourful form.

In an embodiment, the at least one numeral comprises a normal black-and-white numeral.

In an embodiment, the at least one numeral comprises a numeral printed in a stylised and colourful form, and a normal black-and-white numeral.

In an embodiment, the small quadrilaterals further comprise a hard coloured or shaded border that substantially surrounds the entirely of the quadrilateral.

In an embodiment, the quadrilaterals are substantially square.

In an embodiment, the lesson mat has an overall width of substantially 15 quadrilaterals.

In an embodiment, the mat has an overall height of substantially 11 quadrilaterals.

In an embodiment, the central portion has an overall height of substantially five quadrilaterals and a width of substantially five quadrilaterals.

In a fourth aspect the present invention may broadly be said to consist in a method of providing a lesson using at least one education tool as outlined in any one of the first set of the preceding statements, and a lesson mat as claimed in any one of the third set of preceding statements, comprising the steps of:
i) locating at least one pre-prepared education tool within the central portion, with an answer card or card already in position;
ii) locating a plurality of question cards remotely from the lesson mat;
iii) playing an audio recording comprising a number of steps, at least one step requiring interaction with the lesson mat.

In an embodiment, in the step of playing an audio recording, the recording comprises at least the step of a warm-up period.

In an embodiment, in the step of playing an audio recording, the recording comprises at least the step of focussing on a topic, wherein listeners are directed to carry out certain actions that relate to the surrounding portion.

In an embodiment, the certain actions comprise one or more of: finding a specific tile or tiles; acting out an action; finding a specific category of item.

In an embodiment, in the step of playing an audio recording, the recording comprises at least the step of directing the lesson attendee or attendees to retrieve the question cards and to insert these in the at least one education tool.

In an embodiment, in the step of playing an audio recording, the recording comprises a final step of a warm-down or end game session.

In an embodiment, the method of providing a lesson comprises the further step of removing the at least one education tool from the mat and revealing the answers.

In an embodiment, the method of providing a lesson comprises the further step of downloading a new audio recording at intervals.

In a fifth aspect, the invention may broadly be said to consist in a lesson mat, comprising: a flat, regularly-shaped mat body comprising a plurality of printed mosaiced shapes, the printed mosaiced shapes comprising single small quadrilaterals and larger printed pictures.

In an embodiment, the larger printed pictures are the size and shape of four of the single small quadrilaterals arranged in a 2×2 grid.

in an embodiment, the small quadrilaterals are printed with simple geometric shapes, and at least one numeral.

In an embodiment, the at least one numeral comprises a numeral printed in a stylised and colourful form.

In an embodiment, the at least one numeral comprises a normal black-and-white numeral.

In an embodiment, the at least one numeral comprises a numeral printed in a stylised and colourful form, and a normal black-and-white numeral.

In an embodiment, the small quadrilaterals further comprise a hard coloured or shaded border that substantially surrounds the entirely of the quadrilateral.

In an embodiment, the quadrilaterals are substantially square.

In an embodiment, the lesson mat has an overall width of substantially 15 quadrilaterals.

In an embodiment, the mat has an overall height of substantially 11 quadrilaterals.

In a sixth aspect, the invention may broadly be said to consist in a method of providing a lesson using at least one education tool as outlined in any one of the fifth set of the preceding statements, comprising playing an audio recording comprising a number of steps, at least one step requiring interaction with the lesson mat.

In an embodiment, in the step of playing an audio recording, the recording comprises at least a preliminary step of a warm-up period.

In an embodiment, in the step of playing an audio recording, the recording comprises a step of focussing on a topic, wherein listeners are directed to carry out certain actions that relate to the printed mosaiced shapes.

In an embodiment, the certain actions comprise one or more of: finding a specific tile or tiles; acting out an action; finding a specific category of item.

In an embodiment, in the step of playing an audio recording, the recording comprises a final step of a warm-down or end game session.

In an embodiment, the method comprises the further step of downloading a new audio recording at intervals.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a front view of an education tool according to an embodiment of the invention, the tool comprising a flat, substantially A3 sized sheet with a number of small pockets formed across the front surface of the sheet in a three-by-four grid, each small pocket having a clear front-facing window, and also showing a continuous border around two sides of the sheet (a long and a short side), the border having snap-fasteners at the corners.

FIG. 2 shows a rear view of the education tool of FIG. 1, showing detail of two large pockets formed across the rear surface of the sheet, each pocket substantially half the size of the sheet, each large pocket having a dear rearwards-facing window and a clear rear face opening into the front pockets, with an opening or slot to allow items to be slipped into and out of the pocket.

FIG. 3 shows a user sliding two answer sheets into the rear pockets of the education tool of FIGS. 1 and 2, so that a picture faces outwards from the rear face, and a series of answers face inwards through the front face.

FIG. 4a shows the education tool in use, with a user inserting question cards into the small pockets.

FIG. 4b shows the education tool with all of the small pockets filled with question cards.

FIG. 5 shows the removal of the answer sheets from the rear pockets once the question cards have been inserted, to reveal the picture formed by the mosaiced rear faces of the question cards.

FIG. 6 shows a user using the snap-fasteners on the borders of the education tool to fasten a number of the tools together to make a larger sheet from a number of the individual education tools, enabling an individual to answer more questions or it can be used by a group.

FIG. 7a shows nine of the education tool sheets fastened together in a three-by-three grid to form a larger sheet.

FIG. 7b shows a larger mat, with a centre unit formed from a number of connected individual education tools, and an outer border around three sides showing a number of seating locations.

FIG. 8 shows a lesson mat that can be used with the education tool, the lesson mat having a central portion to which six interconnected education tools can be attached in a 2×3 grid, and a surrounding border formed from a mosaic of smaller squares and rectangles.

FIG. 9a shows the lesson mat of FIG. 8 with six education tools of the type shown in FIG. 1 attached to the central portion, the education tools connected at their edges to form the 2×3 grid.

FIG. 9b shows an alternative form of lesson mat

FIG. 10 shows a close-up view of the central portion of the lesson mat with the six education tools attached.

FIG. 11 shows the six education tools reversed or flipped to show the rear faces of the six education tools.

FIG. 12 shows the rear faces of the six education tools with the answer sheets removed to reveal the mosaiced answers.

FIG. 13 shows a close-up view of the rear faces of the six education tools with the answer sheets removed.

FIG. 14 shows a rear view of an alternative form of education tool.

### DETAILED DESCRIPTION

Embodiments of the invention, and variations thereof, will now be described in detail with reference to the figures.

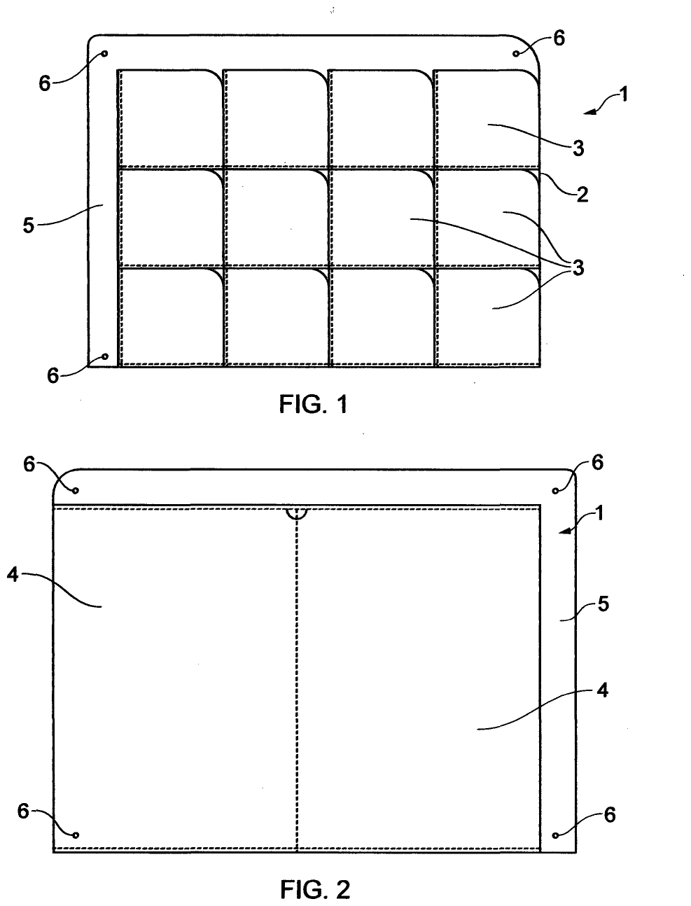

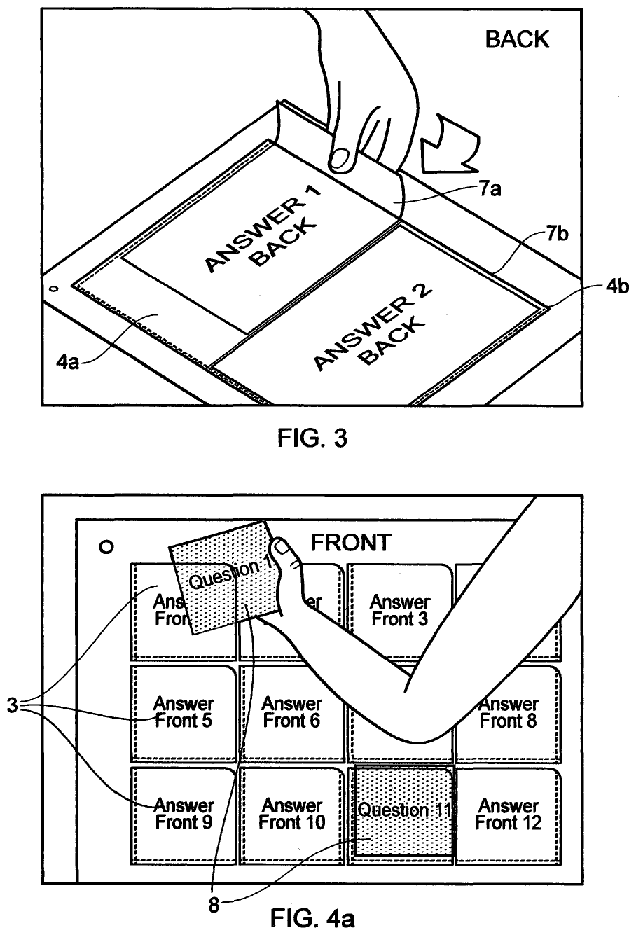

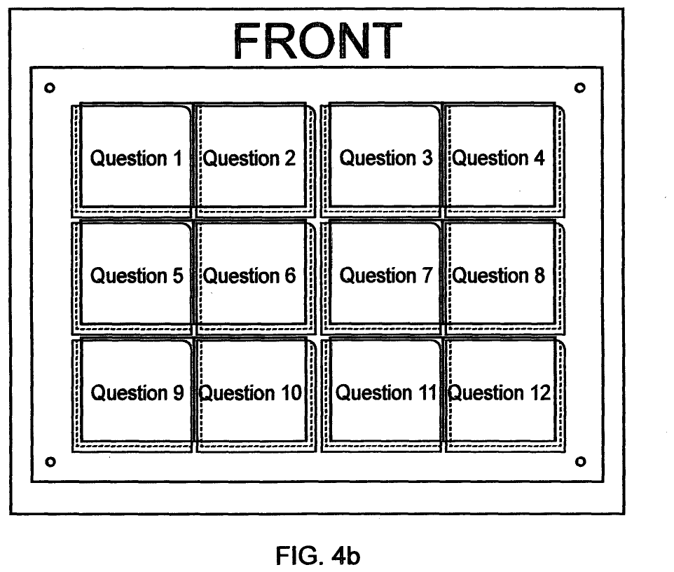

An embodiment of the education tool of the present invention is shown in FIG. 1 and FIG. 2. The education tool 1 in this embodiment comprises a flat, substantially A3-sized backing sheet 2, formed from a clear material, with a number of clear or transparent small pockets 3 formed across substantially the whole of the front surface of the sheet 2 in a three-by-four grid, and two larger rear pockets 4 on the opposite side to the small pockets 3, also formed from a clear or transparent material so that the rear pockets 4 are also transparent. The small front pockets 3 and the larger rear pockets 4 are formed flat against the backing sheet 2, so that they can contain flat cards or other similar material, but so that any ‘not flat’ object placed in the pocket will not easily fit without distorting or stretching the material.

The small or front pockets 3 and the rear pockets 4 in this embodiment are formed by heat welding or stitching clear plastic A4 sheets or similar to the front and rear face of the clear backing sheet 2, with two clear plastic A4 sheets welded or stitched to the backing sheet 2 at, and to form, the edges of the pockets 3, 4. The same or separate sheets can be used to form the pockets 3, 4. Anything in the pockets 3 can be viewed by looking at the front face of the tool 1, and anything behind a pocket 3 can be viewed through the front face of the pocket 3 and the clear backing sheet 2. Each small pocket 3 has an open slot at two sides—the top and the right-hand side as shown in FIG. 1, with the top-right corner rounded to aid a user placing or removing items from the pocket. The front face of the pocket can be folded back roughly on a diagonal that extends from the top-left corner to the bottom-right corner. In variations, the other side of the pockets can be open.

The outer face of anything in the rear pockets 4 can be viewed by looking at the rear face of the tool 1, and the inner face of anything in the rear pockets 4 can be viewed by looking through an empty pocket 3.

As noted above, in this embodiment, the front pockets 3 are formed in a three-by-four grid. The rear pockets 4 are aligned side-by-side on the rear face of the tool 1. Each rear pocket 4 is substantially half the size of the sheet 2. Each large pocket 4 has an opening or openings at the upper edge, and the inner, common edge, to allow the face of the pocket to be folded back roughly on a diagonal that extends from the top-left corner to the bottom-right corner, and for items to be slipped into and out of the pockets 4. The common edge is unsealed so that there is no central block or barrier between the two pockets at the inner common edge. This arrangement allows two A4 sheets to be used, side-by-side, one in each pocket, or for a single A3 sheet to be used, extending across and filling both pockets, with half of the A3 sheet in each pocket.

In an alternative arrangement, the tool is sized so as to receive an single A4-sized answer sheet, with six pockets on the other side arranged in a 2×3 grid to receive six question cards.

In this embodiment, the answer sheet is held in position by two small triangular pockets 204 at opposite corners, as shown in FIG. 14.

A continuous border 5 extends around two sides of the sheet 2, around a long and a short side. Snap-fasteners or pop-fasteners 6 are located at the corners of the border, in the body of the border 5. In alternative forms, velcro could be used, and the border could extend around one, three or four sides of the sheet 2.

Answer cards 7, and question cards 8, are provided with the tool 1. The answer cards 7 are sized to fit into the rear pockets 4, and the question cards 8 are sized to fit in the front pockets 3, each substantially filling its respective pocket (e.g. each answer card 7 will fill a pocket 4 when inserted and each question card 8 will fill a small pocket 3.

The education tool 1 of the present embodiment is used as follows:

Answer cards 7a and 7b are slid into each of the rear pockets 4a, 4b. The answer cards are aligned so that the answers on each card can be viewed by looking at the front face of the education tool 1, with nothing in the front pockets 3. The location of the answers on each card 7a, 7b when they are in the pockets 4a, 4b corresponds to the front pockets 3. That is, each answer on the cards 7a, 7b will fall within a certain area on the card 7a or 7b, and when the card 7a or 7b is located in it's rear pocket, that area will substantially align with the area of a pocket 3. The rear face of the answer cards 7a, 7b shows a distinctive picture, that extends across substantially the whole of the rear face of the answer card 7. Alternatively, the rear of the answer cards can be blank.

With the tool 1 face-up, or front face towards a student, the student or students then slide question cards 8 into the front pockets 3, that correspond to the answer shown on the answer card 7 for that particular pocket. The answers shown could be for example a numeral such as ‘12’, and the question card would have a question such as ‘what is 6+6?’, or ‘what is 4×3?’. Similar questions and answers can be used for teaching English language such as sentence structure or similar, or any other subject where questions can be matched to answers. These are inserted with the question facing outwards (towards the front face). The outer face of the question card contains the question, and the inner face contains part of a larger picture, so that a complete set of question cards 8, correctly positioned and aligned, will form a mosaic-ed larger picture.

Once the whole front face has been filled (all the front pockets 3 have been filled), the teacher can flip the tool 1 over (or similar), in order to access the rear face. The two answer sheets 7a, 7b are then removed by sliding these out of the pockets 4a, 4b so that the rear faces of the question cards 8 become visible through the sheet 2 and the outer layer at the rear formed by the pockets 4a, 4b.

The mosaic-ed picture shown by the question cards 8 inserted into the pockets 3 should, if the questions are positioned correctly, correspond to the picture shown on the rear face of the answer card 7. If it does not correspond, then this will be almost immediately obvious—the teacher can see ‘at a glance’ if there are any differences or discrepancies. If the questions are all correct, then he or she can continue the flow of the lesson uninterrupted. There are any differences, it will be immediately clear where these lie—that is, which question/answer combination is incorrect—so corrective action can be taken very quickly, and no time will be lost to ‘mark’ correct answers. This helps to significantly improve the flow of the lesson. The ‘at a glance’ nature of the answer assessment allows multiple answers to be checked at once, or very quickly. In variations, the rear of the answer card or cards can be blank, with the question cards mosaiced to show a coherent picture or pictures formed from the mosaiced elements.

In the embodiment above, the education tools 1 are each roughly A3-sized. These could also be formed as A4-sized items, or any size as suitable. Different pocket configurations and sizes of question and answer cards are also possible, such as a three-by-three, nine-by-nine, or ten-by-ten grid, or a single rear pocket 4.

It is also possible to produce a similar, but rigid, framework, with open central elements between the framework/grid elements, into which cards or similar can be inserted. The framework would be made from plastic, metal, wood, or any other suitable material. The cards would be inserted and held in position via slots in the grid elements, or any other suitable mechanism. As for the embodiment described above, the question cards are inserted at the front, and the answer cards are inserted at the rear, so that the front of the answer cards can be viewed as the question cards are inserted in front of these, and so that the answer cards can be removed to see the reverse of the question cards forming a mosaic.

When the word ‘pockets’ is used within this specification, it should be taken to include these types of spaces—spaces, open or otherwise, within a rigid framework into which cards can be inserted and held. Similarly, where the word ‘sheet’ is used, this should where appropriate be taken to include a framework of the type described above.

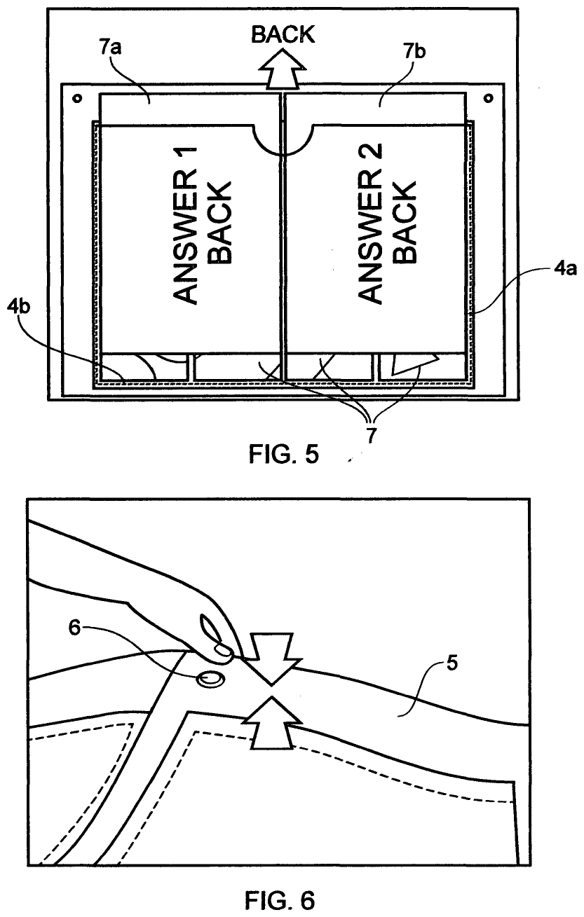

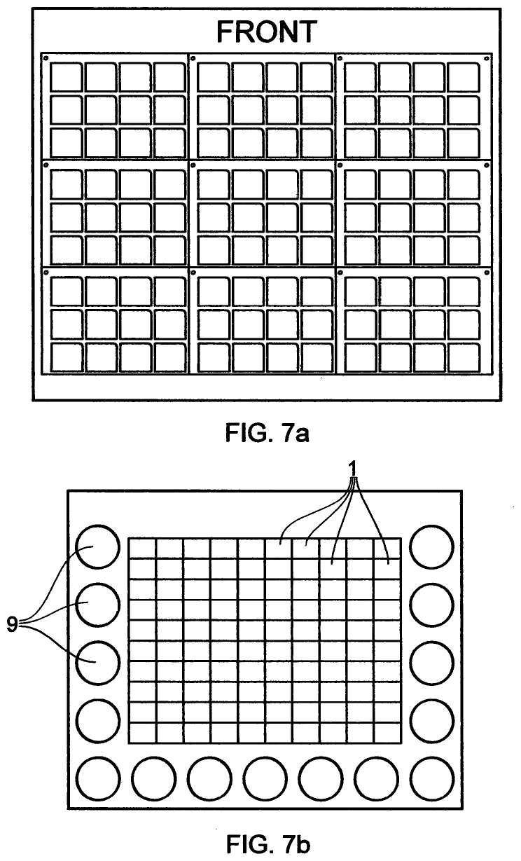

For group work, a number of the individual education tools 1 can be fastened together to form a larger square or rectangle, by using the pop-fasteners 6 that are located at the corners of the border, in the body of the border 5, as shown in FIGS. 5 and 6. These can be used for group work, and a mat can be used with a number of connected individual education tools 1, with seating positions 9 for pupils around the outside of the mat.

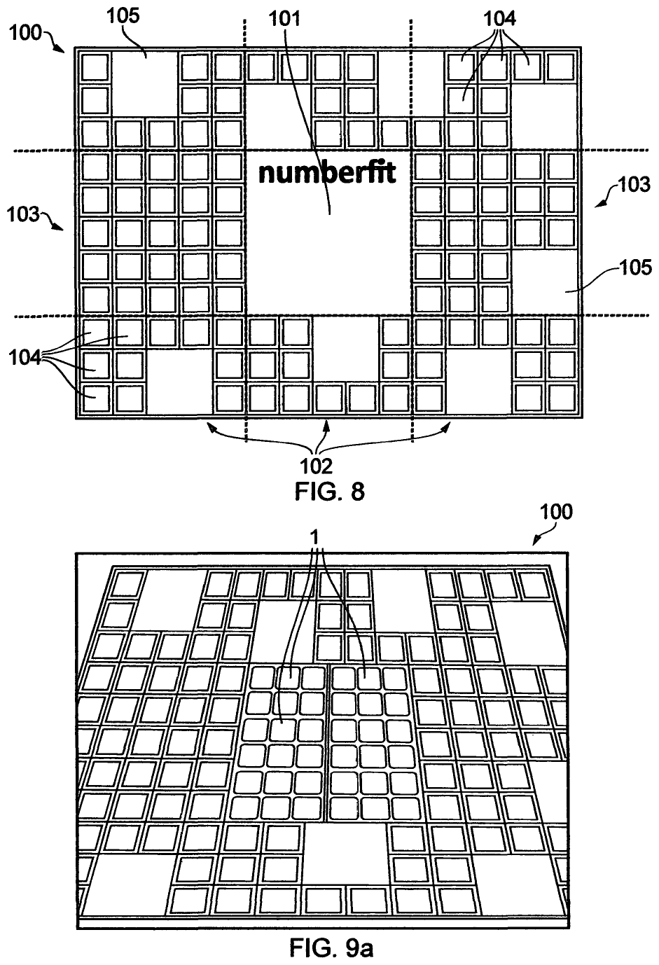

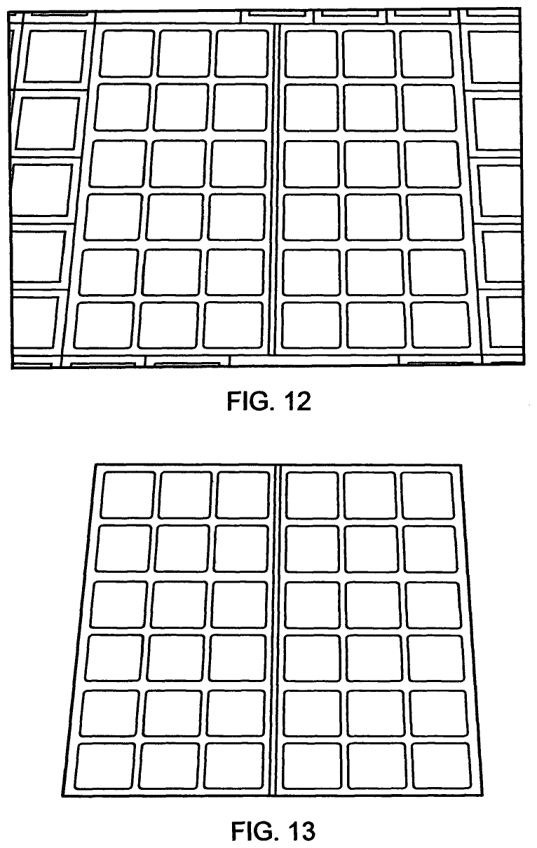

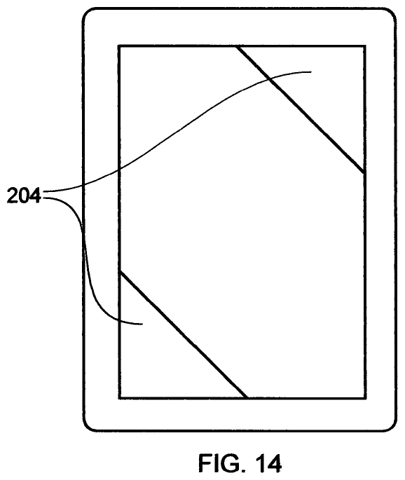

Another way in which the education tool or a number of tools can be used for group work is by using these with a larger lesson mat 100. As shown in FIGS. 8 to 13, in an embodiment, the lesson mat 100 is generally rectangular. The layout of the mat can be generally divided into a 3×3 grid. The central square 101 of the grid of the lesson mat 100 is covered with one half of a hook-and-loop fastener, and is sized so that six of the A3-sized education tools described above can be positioned on it in a 3×2 grid (three vertically and two across). This area can be printed with a picture and/or text, as shown in FIG. 8. The surrounding portion generally forms eight grid squares 102, 103, which are themselves each formed from a sub-grid of small quadrilaterals or rectangles 104. The top and bottom horizontal strips of the 3×3 grid of the lesson mat 100 are each formed from three squares 102. The central horizontal strip of the 3×3 grid of the lesson mat 100 is formed from two rectangles 103 each side of the central square 101. The two rectangles 103 are formed from a 5×5 grid of the smaller quadrilaterals or rectangles 104. The rectangles 102, 103 are printed with pictures, as shown in FIG. 8, each having a larger single picture 105 within it that is the size of a 2×2 grid formed from the smaller rectangles 104, and the remainder is formed from single small rectangles 104. The larger 4×4 pictures are simple items such as animals, bridges, or aeroplanes, with no accompanying text. The single small rectangles 104 show a simple geometric shape such as a triangle, rectangle or star or similar, and a numeral, in both a stylised and colourful form, and a normal black-and-white form. The smaller rectangles 104 are surrounded by a hard coloured or shaded border to help distinguish them from their neighbours. In this embodiment, the smaller rectangles 104 are sized so that a small pre-school child can stand on these—in this particular embodiment, they have a size of 18.5×18.5 cm. The larger rectangles or single pictures 105 have a size sufficient for a small pre-school child to sit on them—74 cm×74 cm in this particular embodiment. A small child of average size will be entirely or substantially entirely within the borders of the larger rectangle if sitting cross-legged. It should be noted that the smaller square could also be borderless or non-bordered.

In alternative forms, the square for attaching the education tools can be located at an edge or corner of the mat 100, and more than one of this type of square can be present. For example, the four corners of the lesson mat 100 could be used in this manner, rather than simply the central square only.

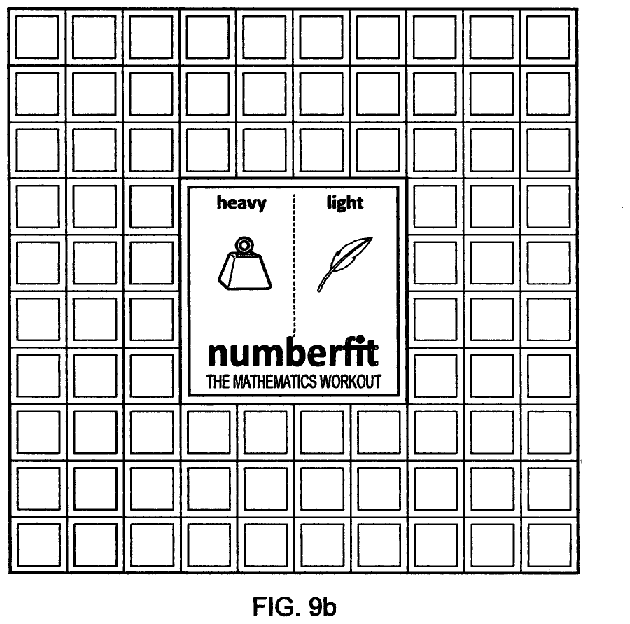

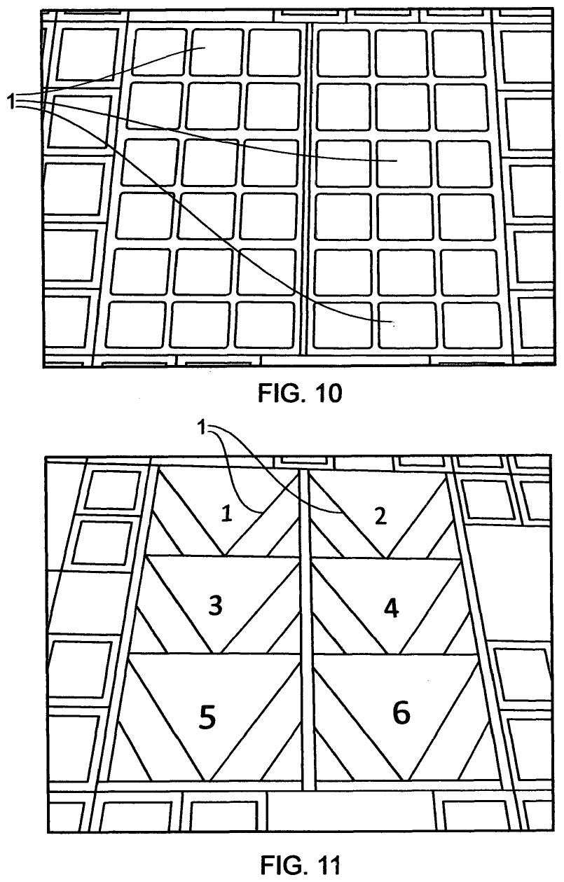

To use the larger lesson mat 100, a user attaches a pre-prepared education tool 1, or a number of pre-prepared and connected education tools 1 (e.g. in this embodiment six, in a 3×2 grid as described above) to the central square 101 so that these can be used in the same manner as already described above, with answer cards already in position. The lesson mat 100 with attached education tools 1 is shown in FIGS. 9a and 10. An alternative form of lesson mat is shown in FIG. 9b, with small rectangles/tiles/quadrilaterals and no larger ones.

The user will then play a recording that outlines a learning session. The recording could be audio-only, combined audio-visual, or video only. In this embodiment, the session comprises:
A warm up period. Interaction with the lesson mat 100 is limited or negligible at this stage. This stage could be for example singing or jumping or other basic movements, along with basic counting. For example, the warm up could be a number hunt, lasting around ten minutes, that may or may not involve using the mat, but which does not use the centre section of the mat.
A period of focus on a topic. This could be for example a hunt around the lesson mat 100, for a specific category of item such as a number, or shape, or size (big or small), as shown on the rectangles 104, 105. A child or children move around the lesson mat 100, and are directed to act out actions and find specific tiles (that is, specific ones of the rectangles 104, 105) by the accompanying audio.
The next period is for the story to direct the child or children to retrieve question cards 8 from other locations around the room, the question card pre-positioned before this. These question cards match the answers shown on the education tool or tools 1 attached to the central square 101. The cards can be in plain view, or ‘hidden’, with instructions on how to find these incorporated into the audio recording. The recording can be paused or even rewound as required, depending on how long it takes the children to work through the process of retrieving the cards, and inserting these into the correct locations. This timescale can vary considerably, but usually on average is around 8-10 minutes.
This is follows by a warm-down or end game session similar to the warm up, where the interaction with the mat is limited. This could be for example an object or card hunt around a larger area such as a room, set to music (from the recording).
The user then detaches and turns over the tool(s) 1 that form the centre of the lesson mat 100. The answers can be checked ‘at a glance’, as outlined above. This sequence is shown in FIGS. 11, 12 and 13. The user can then discuss these with the children as necessary, for example to make corrections. In this embodiment the lesson includes a cliffhanger for the next lesson.

The audio story in this embodiment is approximately 30 minutes long, and is downloaded as part of a subscription, that also includes additional answer and question cards and similar. The story can also be read or delivered aurally, by a teacher or other facilitator. The next audio story or package can be downloaded at intervals that depend on the subscription—for example, every week, fortnight, or month, for example.

It has been found that one teacher or older staff member can use the mat 100 for a lesson as outlined above, with up to eight children.

In variations of the larger lesson mat 100, the central square can have a pattern formed from small and large rectangles 104, 105, the same as the surrounding squares. When using the mat 100 in this variation, the children listen to an audio story or lesson in a similar manner to that described above, following along with the story and/or instructions to different tiles or pictures, and acting out actions and looking for objects on the mat as directed.

In other variations, the story can be an audio-visual story, with a visual as well as an audio component.

Although certain sizes of card and mat have been described, it should be noted that different sizes of all of the items described above can be freely used as required.

1. An education tool, comprising:
a flat sheet having a front face and a rear face, and comprising a plurality of small pockets formed across at least part of the front face, and at least one rear pocket formed across at least part of the rear face;
a plurality of answer cards, each answer card and each at least one large pocket mutually configured so that an answer card can be inserted into the large pocket to show a series of answers towards the front face;
a plurality of question cards, the inner face of each question card showing part of a larger picture, the outer face showing a question;
the flat sheet, question cards, and answer card all configured so that the question cards can be inserted within the small pockets over an answer showing through the flat sheet from an answer card inserted in the rear pocket, and further configured so that when all the question cards are inserted in the correct answer locations, the part pictures on their rear faces will mosaic to show at least one coherent picture.

2. An education tool as claimed in claim 1 wherein the answer card or cards is/are further configured to show a picture towards the rear face, the picture corresponding to the correctly-mosaiced picture on the rear faces of the question cards.

3. The education tool as claimed in claim 1 wherein the flat sheet is substantially A3-sized.

4. The education tool as claimed in claim 1 wherein the flat sheet is substantially A4-sized.

5. The education tool as claimed in claim 1 wherein the small pockets are formed and arranged in a three-by-four grid.

6. The education tool as claimed in claim 1 wherein the at least one rear pocket is a pair of substantially identical pockets.

7. The education tool as claimed in claim 1 wherein the flat sheet and the pockets at least partly formed from a substantially transparent material.

8. The education tool as claimed in claim 1 wherein the front and/or rear pockets are formed by heat welding and/or stitching a transparent plastic material.

9. The education tool as claimed in claim 1 further comprising a border, extending from at least one edge of the sheet, and comprising a connection means to allow two or more education tools to be connected together.

10. The education tool as claimed in claim 9 wherein the border extends from at least two edges of the sheet.

11. The education tool as claimed in claim 9 wherein the border extends around at least two edges of the sheet.

12. The education tool as claimed in claim 9 wherein the connection means comprises at least one snap-fastener.

13. The education tool as claimed in claim 9 wherein the connection means comprises velcro.

14. A method comprising:
i) providing an education tool comprising a flat sheet having a front face and a rear face, a plurality of small pockets formed across at least part of the front face, and at least one rear pocket formed across at least part of the rear face, a plurality of answer cards, a plurality of question cards;
ii) inserting at least one answer card into the at least one rear pocket of the education tool, the at least one answer card or cards having an answer or answers on the front face, the at least one answer card aligned so that the answer or answers can be viewed through the front face of the education tool;
iii) inserting a plurality of question cards into the front pockets over the answer or answers, each of the question cards having a question on the outer face and a portion of a mosaiced picture on the rear face, the portions of mosaiced picture on the rear faces forming a larger overall picture once all the question cards are inserted in the correct locations; and
iv) removing the at least one answer card so as to view the rear faces of the question cards, and assessing the correctness of the mosaiced picture thus revealed.

15. A method of use as claimed in claim 14 comprising the further initial step of fastening two or more education tools to one another.

16. The education tool as claimed in 1 and further including a lesson mat, the lesson mat comprising:
a flat, regularly-shaped mat body having an education tool portion adapted so that flat sheet can be located in/on the education tool portion; and
a mosaic portion comprising a plurality of printed mosaiced shapes.

17. The education tool as claimed in claim 16 wherein the education tool portion is configured to receive a plurality of the flat sheets.

18. The education tool as claimed in claim 17 wherein the education tool portion is a central portion.

19. The education tool as claimed in claim 17 wherein the central portion can receive six of the flat sheets.

20. The education tool as claimed in claim 19 wherein the central portion is shaped to receive the flat sheets in a 3×2 grid configuration.

21.-57. (canceled)
